(19) United States
(12) Patent Application Publication
(10) Pub. No.: US 2008/0272887 A1
(43) Pub. Date: Nov. 6, 2008

(54) Rack Position Determination Using Active Acoustics

(75) Inventors: Thomas M. Brey, Cary, NC (US); Richard Edwin Harper, Chapel Hill, NC (US); Thomas Dixon Pahel, Raleigh, NC (US); William Joseph Piazza, Holly Springs, NC (US)

Correspondence Address: IBM CORPORATION (SS/NC);c/o STREETS & STEELE, 13831 NORTHWEST FREEWAY, SUITE 355, HOUSTON, TX, 77040, US

(73) Assignee: INTERNATIONAL BUSINESS MACHINES CORPORATION, Armonk, NY (US)

(21) Appl. No.: 11/742,613

(22) Filed: May 1, 2007

(51) Int. Cl. H04Q 5/22

(52) U.S. Cl. 340/10.1; 367/6

(57) ABSTRACT

Systems and methods for determining the position of a component rack within a data center and/or the positions of components within the component rack. In one embodiment, a plurality of ultrasonic reference transponders are disposed in fixed locations throughout a data center. The reference transponders communicate with one another to establish a reference coordinate system for the data center. Each component rack in the data center is provided with an ultrasonic rack transponder that can be triangulated with the reference transponders to determine the position of a component rack. This “rack position” information can be used by a system controller to control the components and to help regulate the data center within pre-specified operating parameters. If a problem occurs in the data center, information about the position of the affected components and component racks may be used by the system controller or a system administrator to help remedy the problem.

### BACKGROUND OF THE INVENTION

1. Field of the Invention

The present invention relates to systems and methods for determining the position of computer equipment in a data center. The present invention also relates to the reporting of equipment positions and control of the computer equipment according to its position.

2. Description of the Related Art

Computer equipment is commonly stored or mounted on racks in a data center. Each rack can accommodate multiple components in an organized arrangement that makes efficient use of space and places the computer equipment and associated infrastructure within easy reach of a system administrator. Much of the computer equipment in a data center is in the form of servers stored in enclosures stacked in standardized racks, such as 19 inch rack cabinets. The IBM SYSTEM X servers and IBM eServer BLADECENTER® are examples of compact rack-mountable server systems. (IBM, SYSTEM X, and BLADECENTER are trademarks of International Business Machines Corporation of Armonk, N.Y.).

A data center can be rather large, occupying a single room, a floor of a building, or even an entire building. Keeping track of the location of each component of a computer system is, therefore, important. If it is desired to reconfigure a network in a data center, for example, or if a particular component, such as a server, generates a failure alert, a system administrator must be able to locate the components quickly. However, the system administrator may still have trouble identifying the physical location of a component, particularly, for example, if the component is one of several hundred, or mounted in a rack that is in a room with dozens of other racks.

System management software is available to help the system administrator monitor computer components such as servers, storage devices, and network routers, and to warn the system administrator if and when intervention is required for a particular component. Non-limiting examples of management software applications include IBM Netfinity Manager, IBM Netfinity Director, Tivoli TME 10, and Compaq Insight Manager. System alerts can also include warnings of potential problems so that the system administrator can take preventive measures to avoid a catastrophic failure. Typical system management software applications include a system management console program and a system management agent. The console program typically resides on the system administrator's workstation, and the management agent resides on the managed components. The system administrator is able to monitor each component through the cooperation between the console program and the management agents. Similar system management roles may alternatively be provided by a service processor residing on a component to be monitored or, in the case of server blades, an Advanced Management Module.

One method of locating or tracking the physical location of a piece of equipment involves manually attaching a label, such as a bar code sticker, to each rack and/or component and scanning the bar code number with a reading device. This method, however, requires either a person operating the bar code reader to scan each component, or having the component moved past a stationary scanner. Both tasks can be time consuming, inefficient and costly, while confidence in the accuracy of the information declines over time. To allow system management software to be aware of the physical location of the component, the user typically performs the burdensome task of manually entering the identity and location of each component into the system. As components are added, relocated, removed, or replaced, the physical scanning or data entry methods can easily miss or misidentify components. Thus, the accuracy of this system is also highly susceptible to human error.

Another method of tracking the physical location of a component involves embedding an electrical memory device in the component and providing a physical connection between the enclosure and the component. When the component is placed in the enclosure, a system communicates with the enclosure to read and store the memory information of the component. Such a system then allows the user to enter search terms and the system illuminates an indicator light near the component, which matches the user's search criteria. However, the physical connection between the enclosure and the component, such as a cable or connector, can become a source of failure, requiring human intervention and maintenance. Moreover, the connection between the system and the enclosure must support the protocol needed to read the electrical memory device and control the indicator light. Even with the indicator illuminated, an administrator may have to search a large area of the data center for the indicator on the item sought. In addition, multiple indicators may be illuminated concurrently, making it more difficult to determine which indicator is sought.

U.S. Pat. No. 6,762,691 provides a method and system for automatically and continuously tracking rack-mounted computer equipment. An optical system mounted to the sidewall of a rack can transmit information about the position of equipment with respect to the rack. The system can also transmit information about each component within the rack, such as its device serial number. This information can then be automatically reported to a system management software application used by the system administrator.

Tracking and locating individual computer components remains an important area of development in the management of rack-mounted computer systems, particularly in view of the increasing complexity of these computer systems. Therefore, continued improvements and refinements in determining the position of computer components are sought.

### SUMMARY OF THE INVENTION

The present invention provides systems and methods for determining the position of racks and computer components mounted on racks within a data center.

According to a first embodiment, one or more ultrasonic rack transponders are provided that are associated with a respective one or more component racks in a data center. At least two ultrasonic reference transponders are provided at non-collinear, fixed locations with respect to the data center. The position of a selected component rack with respect to the data center is determined by ultrasonically communicating between the associated rack transponder and the at least two reference transponders.

According to a second embodiment, a computer program product comprises a computer usable medium including computer usable program code for determining the position of a component rack in a data center. The computer program product includes computer usable program code for detecting the position of the component rack with respect to the data center by triangulating the associated rack transponder with respect to at least two reference transponders disposed at non-collinear locations in the data center.

According to a third embodiment, a system for detecting the position of computer equipment in a data center is provided. A plurality of ultrasonic reference transponders is disposed at non-collinear locations in the data center. A component rack is configured for housing a plurality of components. An ultrasonic rack transponder is disposed in a fixed relationship with respect to the component rack. The ultrasonic rack transponder is configured for communicating with the reference transponders for determining the position of the component rack with respect to the data center.

Other embodiments, aspects, and advantages of the invention will be apparent from the following description and the appended claims.

### BRIEF DESCRIPTION OF THE DRAWINGS

FIG. 1 is a side elevation view of a rack-based computer system (“rack system”) in which the positions of racks and the positions of components mounted in the racks may be determined according to the invention.

FIG. 2 is a plan view of a data center configured with a rack position sensing system (RPSS) according to one embodiment of the invention.

FIG. 3A is a schematic diagram illustrating the use of three reference transponders to establish a reference coordinate system for the data center.

FIG. 3B is a schematic diagram illustrating the use of additional reference transponders positioned throughout the data center to optionally expand the coverage area of the reference transponders.

FIG. 3C is a schematic diagram illustrating the determination of rack position relative to the coordinate system by triangulating a rack transponder with the reference transponders.

FIG. 4 is a perspective view of one of the racks of FIG. 1, configured with an optional component position tracking system (CPSS).

FIG. 5 is a partial, elevation view of the rack of FIG. 4, including a component whose position may be determined using the CPSS.

FIG. 6 is a side view of the LED strip included with the CPSS of FIG. 5, illustrating the transmission of information about the position of a component within the rack.

FIG. 7 is a flowchart illustrating a method of determining positional information of a data center and controlling the data center in response, according to one embodiment of the invention.

FIG. 8 is a schematic diagram of a computer system that may be configured for tracking and controlling computer equipment according to the invention.

### DETAILED DESCRIPTION OF PREFERRED EMBODIMENTS

The present invention provides systems and methods for determining the position of racks and computer components mounted on racks within a data center. In one aspect of the invention, a rack position sensor system (RPSS) is used to determine the position of the rack with respect to the data center. In another aspect of the invention, a component position sensor system (CPSS) determines the position of components with respect to a rack in which they are mounted. The positional information provided by the RPSS, and optionally including positional information provided by the CPSS, may be communicated to a local controller, such as a baseboard management system (BMC) residing on each of the components, thereby informing each of the components of the position of their rack with respect to the data center, and optionally also informing each of the components of their position within the rack. The positional information may also be communicated to a workstation used to control computer equipment in the data center globally. The components may be controlled by their respective local controllers and/or by the global system management software in response to the positional information.

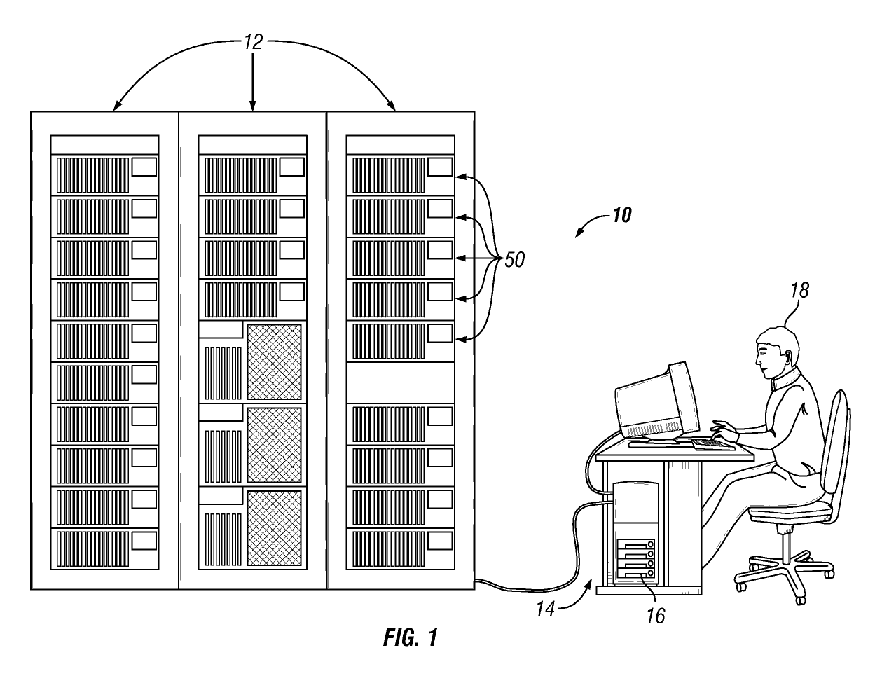

FIG. 1 is a side elevation view of a data center 10 containing multiple component racks 12. Each component rack 12 has multiple components 50 disposed therein. Examples of components 50 include electronic devices, such as computer servers, data storage devices, and communication network routers. The positions of the component racks 12 with respect to the data center 10, and, optionally, the positions of the components 50 with respect to the component racks 12, may be determined and communicated according to the invention. A workstation 14 is networked with the components 50 for monitoring and controlling the components 50 globally. The workstation 14 includes system management software 16. The system management software 16 is typically installed on the workstation 14 to help a system administrator 18 monitor the components 50, and to warn the system administrator 18 if and when intervention is required for a particular component. A system management agent or hardware service processor may be installed on each of one or more of the components 50 for controlling the components 50 locally in accordance with instructions from the system management software and for reporting positional information to the system management software. The system management software, typically in cooperation with the system management agent or service processor residing on each of the components 50, may thereby control the data center 10, either alone or in response to input from the system administrator 18 and/or as a function of one or more system parameters monitored by the workstation 14. For example, the workstation 14 may selectively monitor and control the power distribution among the components 50, adjust blower speeds and associated airflow rates as needed for properly cooling the data center 10 and/or its components 50, throttle the components 50, or individually power the components 500N or OFF. The workstation 14 may also control the data center 10 in response to positional information provided to the workstation 14 by the system management agent or hardware service processors of each of the components 50.

If certain conditions are detected in a component 50, the system management software 16 may issue an appropriate message to the system administrator 18. The message may include an identification of the detected condition, position of the specific rack 12 housing the component 50 with respect to the data center 10 and, optionally, the position of the component 50 with respect to the specific component rack 12. The system administrator 18 may use this positional information to locate the component 50 that is the subject of the message. The system management software 16 is optionally capable of presenting a graphical representation of the physical location of the component to the system administrator. In addition to optionally informing an administrator of the physical location of the equipment originating an alert, the system management software may also optionally respond independently of the system administrator, taking into account the type of alert and the physical position of the rack and/or the components in the rack. For example, in response to an alert associated with a thermal problem, the system management software may selectively reduce the workload of other equipment in the vicinity of the equipment originating the alert, due to the possibility that, for example, the thermal problem is being caused by insufficient flow of cool air in this vicinity.

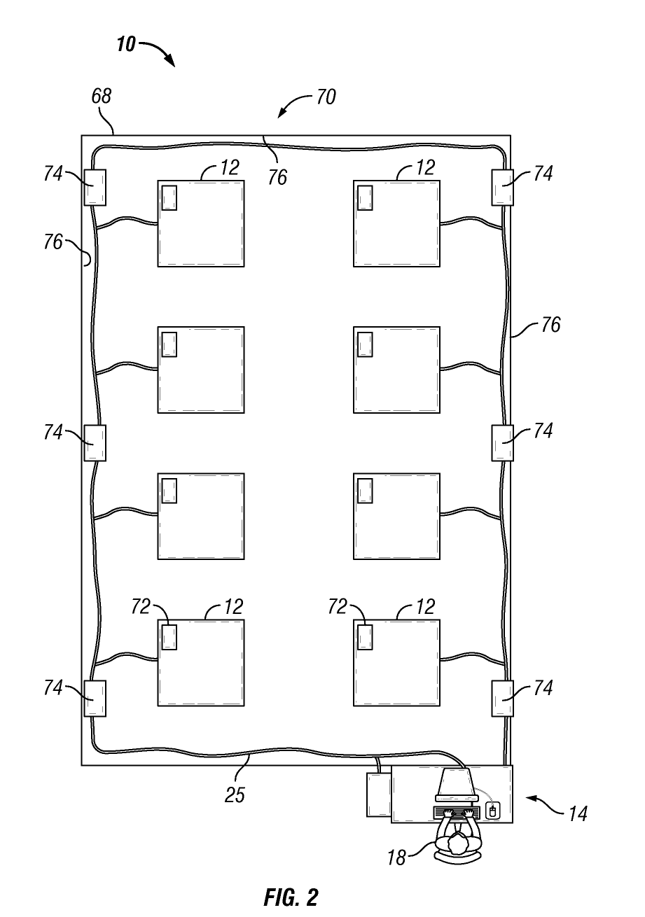

FIG. 2 is a plan view of the data center 10 configured with one embodiment of a rack position sensing system (RPSS) 70 according to the invention. The RPSS 70 includes six ultrasonic reference transponders 74 distributed throughout the data center 10. The RPSS further includes eight ultrasonic rack transponders 72, each associated with a respective one of the eight component racks 12 for determining the position of each component rack 12 with respect to the data center 10. As discussed further below, a subset of at least three of the reference transponders 74 may be used for establishing a coordinate system, such as a Cartesian coordinate system, for the data center 10. The positions of this subset of the reference transponders 74 may be determined through ultrasonic communication between the reference transponders 74. Alternatively, the positions/coordinates of the reference transponders 74 may be programmed into, manually entered, or otherwise supplied to the system management software. To expand the coverage of the RPSS 70, the positions of other reference transponders 74 (in addition to the subset used to establish the coordinate system) may similarly be determined.

The rack transponders 72 may then communicate using ultrasonic signals with any group of at least three (or, in some limited cases described below, with at least two) reference transponders 74 to determine the position of the component racks 12 with respect to the coordinate system. The rack transponders 72 may then communicate their own position information to the workstation 14, such as by using an Ethernet line 25. The rack transponders 72 are typically disposed on their associated component racks 12. The rack transponders 72 are preferably rigidly coupled to the respective component racks 12, so that if the position of the component racks 12 were to change, the position of the rack transponders 72 would also change a corresponding amount.

In some embodiments, the reference transponders are disposed along a perimeter of a data center room. For example, in the embodiment of FIG. 2, the reference transponders 74 are mounted on opposing walls 76 of the data center room 68. Alternative mounting examples include securing the reference transponders 74 to posts extending upwardly from the floor, or suspending the reference transponders 74 from a ceiling of the room 68. The reference transponders 74 are preferably positioned at about the same elevation as the rack transponders 72. The rack transponders 72 and the reference transponders 74 may be positioned above the component racks 12 to provide relatively unobstructed signal transmission pathways between the rack transponders 72 and the reference transponders 74.

Unless the floor plan of the data center is reconfigured, such as by changing the positioning of the walls, the reference transponders 74 are typically positioned at fixed locations throughout the data center 10, so that the positions of the racks 12 may be reliably determined. Thus, the reference transponders 74 may have established positions as part of a “permanent” installation in the data center 10, to provide a reliable frame of reference for determining rack position even as equipment and racks are added, removed, or repositioned over time. In particular, repositioning the coordinate-establishing reference transponders will modify the very coordinate system. However, such a modified coordinate system may, nevertheless, be used as a frame of reference to describe the positions of items within the data center.

The distance between two ultrasonic transponders, e.g. between any two of the rack transponders 72, any two of the reference transponders 74, or between a rack transponder 72 and a reference transponder 74, may be determined using a cooperative process involving the two transponders. The process includes a first transponder generating a first signal, a second transponder immediately generating a second signal in response to receiving the first signal, the first transponder receiving the second signal, and then computing the distance between the first and second transponders according to how much time elapses between generating the first signal and receiving the second signal. Preferably, the first and second signals are at two different frequencies, to help the first transponder differentiate between the second signal and any reflections of the first signal that might occur within the data center. However, the first and second signals may alternatively be at the same frequency, and other techniques for distinguishing the signals may be applied, such as “spread-spectrum” and/or modulation techniques known in the art. The use of different frequencies for the different transponders may also be used to identify which transponders are communicating. For example, each transponder may be “assigned” to operate on a different frequency, so that a transponder receiving a signal may know which other transponder is sending the signal by virtue of the frequency. Alternatively, the transponders may provide digital identification information in the signals they generate.

By computing distances between reference transponders and applying mathematical principles, information about the positions of the transponders may be determined. For example, geometrical theorems provide that a triangle may be completely determined with knowledge of three sides (“SSS”), two sides and an included angle (“SAS”), and two angles and an included side (“ASA”). To illustrate, according to the SSS theorem, the position of a third transponder may be inferred from the computed distances between the third transponder and each of two reference transponders, wherein the distance between the two reference transponders is known. In practice, the SSS theorem may be the only one used. However, it is possible to establish a coordinate system in a rectangular room, for example, where the reference transponders are positioned in the corners known to form right angles. Accordingly, it may be necessary only to input or measure the distance between two of the reference transponders to satisfy the SAS theorem.

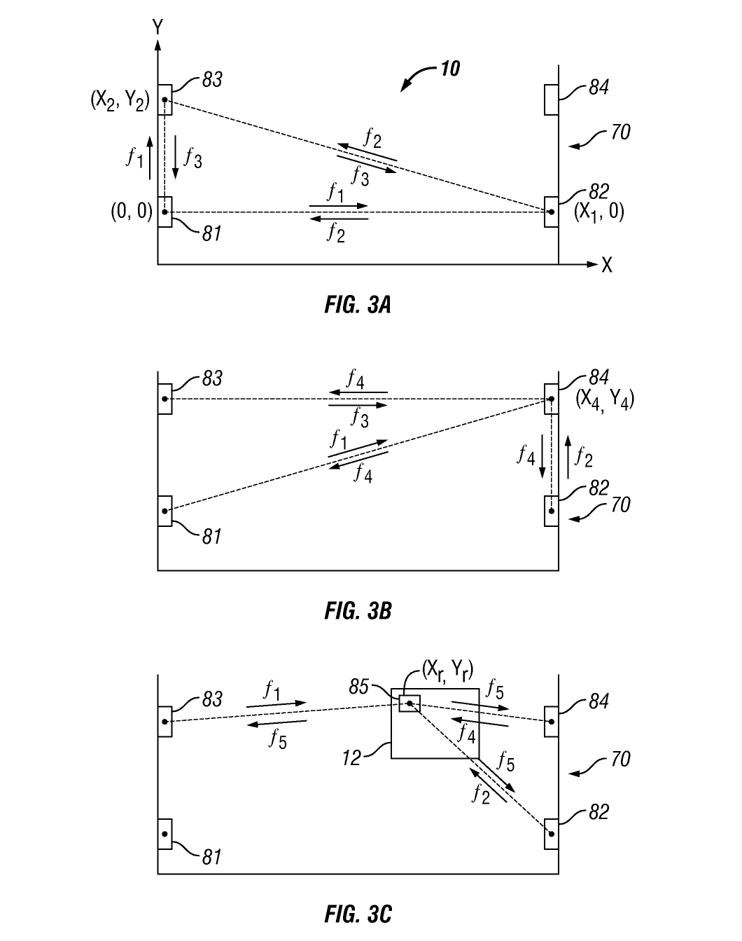

FIGS. 3A-3C are schematic diagrams illustrating the use of the RPSS 70 to establish a reference coordinate system using three reference transponders 81, 82, 83 (FIG. 3A), optionally expand coverage with at least one additional reference transponder 84 (FIG. 3B), and then to determine the position of one of the component racks 12 with respect to the coordinate system by triangulating a rack transponder 85 with selected reference transponders (FIG. 3C).

Beginning with FIG. 3A, a coordinate system may first be established with respect to the data center 10 using the first, second, and third reference transponders 81, 82, 83 of the RPSS 70. The first reference transponder 81 may be arbitrarily selected as the origin of a coordinate system (X,Y). The first reference transponder 81 may record its position at the origin. The second reference transponder 82 is used to establish the x-axis of the coordinate system (X,Y) by ranging with the first reference transponder 81. In particular, the second reference transponder 82 generates a signal on frequency f2. The first reference transponder 82 receives the first signal and immediately responds with a signal on frequency f1, which is intercepted by the second reference transponder 81. The distance between the first and second reference transponders 81, 82 can be computed from the known velocity of the ultrasonic signals and the time elapsed between the transmission of the first signal by the first reference transponder 81 and the receipt of the second signal by the first reference transponder 81. The position of the second reference transponder 82 is designated accordingly as (X1,0). A vector (X1,0) from the first reference transponder 81 (the origin) to the second reference transponder 82 defines the X-axis. Because the two reference transponders 81, 82 have been installed in a position to lie along one of the walls, the X-axis they define is generally aligned with that wall.

The third reference transponder 83 may similarly communicate with the first and second reference transponders 81, 82 to determine the relative position of the third reference transponder 83. The reference transponder 83, as a third “point,” establishes a plane, which is parallel to the floor of the data center if all three reference transponders 81-83 are at the same height. The reference transponder 83 does not have to lie exactly on the Y-axis. Thus, the location of the third reference transponder 83 may be generally designated (X2, Y2), as shown. If the third reference transponder 83 happens to lie in a direction perpendicular to the X-axis, as shown, then the location of the third reference transponder is (0,Y2). Each reference transponders 81, 82, 83 may store its own position information, and optionally communicate this position information to each of the other reference transponders 81, 82, 83.

An alternative to establishing the positions of the reference transponders ultrasonically, as in FIGS. 3A and 3C, is to instead manually enter their positions into the system management software. For example, a data center designer or system administrator may measure the positions of the reference transponders and program or enter this information to a workstation. Thereafter, the reference transponders may simply generate signals in response to any signals received from rack transponders, so that the rack transponders may determine their locations. This may simplify the establishment of the coordinate system by avoiding the need to communicate ultrasonically between the reference transponders. This may also simplify the construction of the data center by avoiding the need to wire the reference transponders in communication with the workstation.

Additional reference transponders may be used to expand the coverage area of the RPSS 70. This may be particularly useful in large data center installations, or to provide shorter distances between reference transponders to increase the reliability of communications there between. FIG. 3B illustrated the addition of a fourth reference transponder 84. Here, by way of example, the fourth reference transponder 84 ranges with the first and third reference transponders 81, 83 to determine its location—a fourth point (X4,Y4) of the coordinate system. Alternatively, the fourth reference transponder 84 may range with the first and second reference transponders 81, 82 or the second and third reference transponders 82, 83, or any other two reference transponders within range whose positions with respect to the coordinate system are known. After expanding the coverage of the RPSS 70 with the fourth through nth reference transponders, any two reference transponders in clear communication with a given rack transponder may be selected for subsequently determining the position of a selected component rack 12. This expands the coverage of the RPSS 70 by providing additional reference transponders throughout the data center 10 with respect to which the positions of the racks 12 may be determined.

After establishing the data center coordinate system, the position of the component racks with respect to the data center 10 may be determined by ranging their respective rack transponders with two reference transponders (a total of three transponders being required for triangulation). FIG. 3C illustrates, for example, the triangulation of the rack transponder 85 with the second, third, and fourth reference transponders 82, 83, 84 (which are the three reference transponders nearest to the rack transponder 85) to determine the position of the rack transponder 85 (and, at least by inference, the position of the component rack 12) with respect to the data center 10. In this example, the rack transponder 85 generates an ultrasonic signal on a frequency f5 and the reference transponders 81, 82, 84 each generate a signal in response. The rack transponder 85 then has enough information, according to how long it takes to receive these responsive signals, that the management agent, service processor, or system management software can compute the coordinates (Xr,Yr) of the rack. Thus, the position of the component rack 12 with respect to the data center 10 is determined, assuming a two-dimensional system. This process may also be done with only two reference transponders whose positions within the coordinate system are already known. However, communicating with three reference transponders allows for cross checking of the coordinates, since each pairing of the reference transponders can form a different triangle with the rack transponder.

It should be recognized that the position of a rack transponder may be determined or deduced with as few as two reference transponders if the heights of the rack transponder and reference transponders are known. Two reference transponders (positioned, for example, along a wall of the data center in two corners), may establish the endpoints of a line segment parallel with the wall. A rack transponder may then range with each of the two reference transponders to determine its position on either side of that line segment, thus narrowing the position of the rack transponder to two possible positions—one inside the data center, and one outside the data center. Provided with information regarding the placement of the two reference transponders along a wall of a rectangular data center room, the system management software used to control the data center may use a process of elimination to rule out the location outside the data center, thus determining the probable location of the rack transponder to be the computed position within the data center.

Referring again to FIG. 3C, the position of the component rack 12 may be determined inferentially from the position of the rack transponder 85. The position of the component rack 12 may be reported, for example, as the position (Xr,Yr) of its associated rack transponder 85. Alternatively, because the rack transponder may be located at a known position with respect to the component rack 12 or, optionally, at a known spacing from the component rack 12, the position of the component rack 12 may be computed with reference to the coordinates of the rack transponder 85. For example, the position of the component rack 12 may be computed with respect to the ultrasonically determined coordinates of the rack transponder 85 using simple vector addition or subtraction. The “position” of the component rack 12 may be reported as the coordinates of a reference feature of the component rack 12, such as a corner of the component rack 12 or the center of the component rack 12.

The above discussion describes the use of a two-dimensional coordinate system (X,Y) for locating and tracking the position of component racks with respect to the data center. Generally, the two-dimensional coordinate system (X,Y) is most useful when oriented in a horizontal plane, i.e. parallel to the floor, in that movement of the component racks 12 typically occurs parallel to such a plane. Those skilled in the art will appreciate, however, that the positional information may be extended to the use of a non-horizontal two-dimensional coordinate system, or to a three-dimensional coordinate system (X,Y,Z) that includes vertical elevation or height. However, it would generally be necessary for a rack transponder to triangulate with at least three reference transponders in order to obtain three dimensional coordinates.

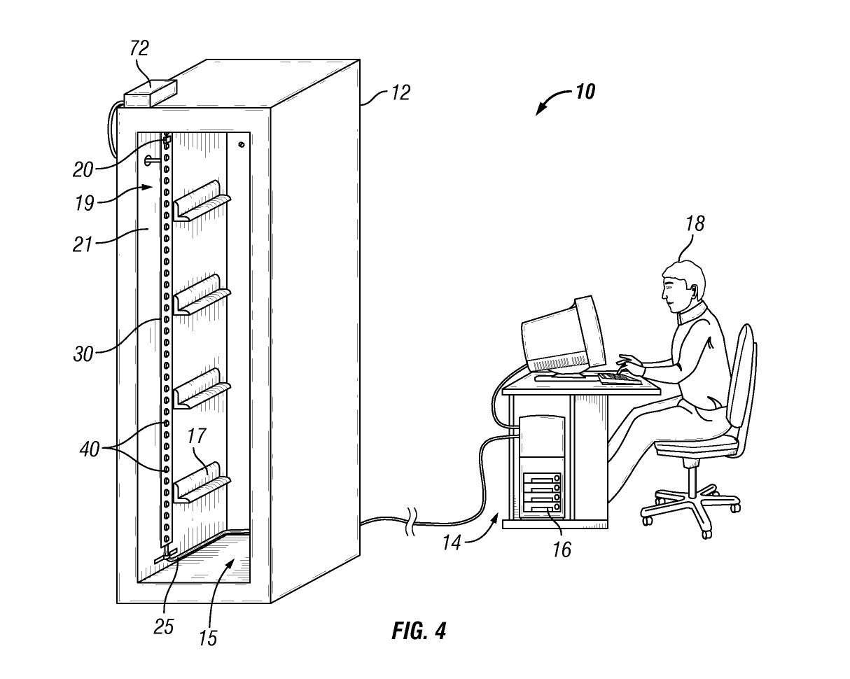

FIG. 4 is a perspective view of one of the component racks 12 of FIG. 1 configured with an optional component position tracking system (CPSS) generally indicated at 19. The optional CPSS 19 is used to determine the position of components with respect to the component rack 12. This component position information may be used to supplement the rack position information determined using the RPSS (described above), to provide more detailed information regarding equipment in the data center 10. The component position information and rack position information may be used together to manage the data center 10. For example, the system administrator may receive component alerts that identify both the location of a rack and the location of a component within that rack.

The component rack 12 includes an interior portion 15 for receiving components such as servers, storage devices, network routers, or other computer hardware devices, or optional enclosures that house such computer hardware devices. The optional enclosures may include a plurality of bays, such as standardized “1U” server bays for removably receiving server blades or other devices. A plurality of shelf supports 17 are each disposed within the interior portion 15 of the component rack 12 for removably supporting the components or enclosures within the component rack 12. In one configuration of the component rack 12, the components may be disposed directly on shelves supported on the shelf supports 17, and the CPSS 19 may sense their positions directly. In another configuration of the component rack 12, hardware enclosures may be supported on the shelf supports 17, and the CPSS 19 may determine the positions of the enclosures. The ultrasonic transponder (“rack transponder”) 72 disposed on the rack 12 may be used, as described above, for determining the position of the component rack 12 within the data center 10 (i.e., the “rack position”). The CPSS 19 and the rack transponder 72 are in communication with the workstation 14 using the Ethernet line 25.

The CPSS 19 includes a plurality of signal emitters, which in this embodiment are light-emitting diodes (LEDs) 40 disposed on an LED strip 30. The LED strip 30 is vertically mounted on an interior side wall 21 of the component rack 12, extending from about the top of the component rack 12 to about the bottom of the component rack 12. The location of the LED strip 30 within the component rack 12 will likely vary from that shown in the figure, depending on a number of factors, such as the type of rack used and the anticipated dimensions and locations of components installed in the rack. Each of the LEDs 40 is preferably disposed at known locations with respect to the LED strip 30 or the component rack 12.

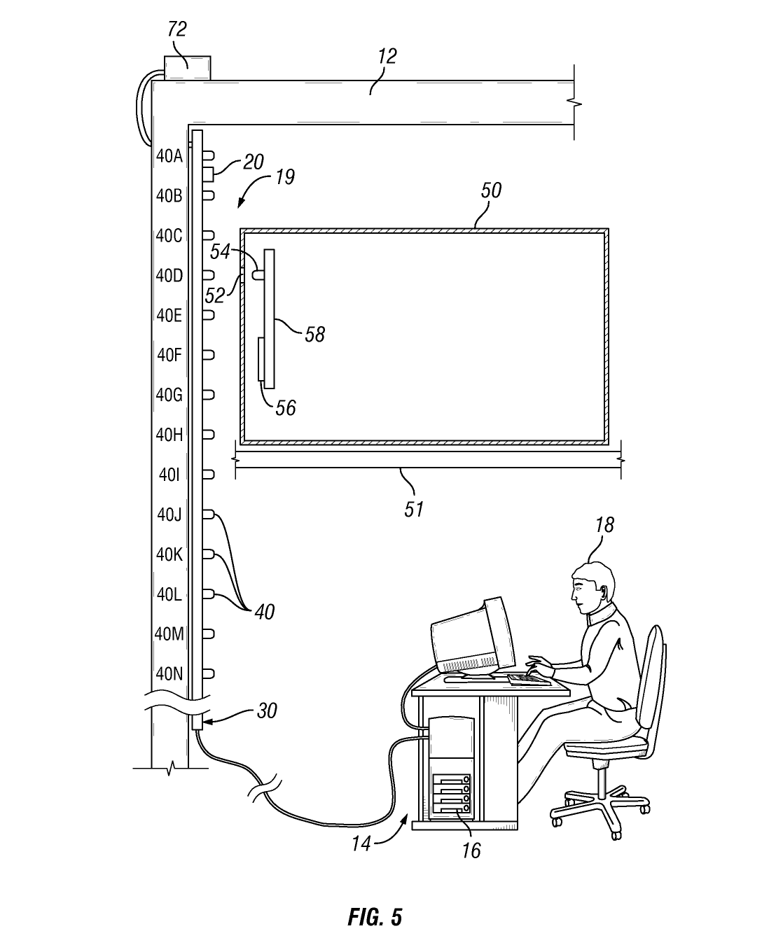

FIG. 5 is a partial elevation view of the component rack 12 with a component 50 whose position may be determined using the CPSS 19. The component 50 is mounted on a shelf 51 inside the component rack 12, in proximity to the LED strip 30. The LEDs 40 are individually labeled 40a-40n. A microcontroller 20 for controlling the LEDs 40 is optionally mounted, as shown, on the LED strip 30. The microcontroller 20 directs the LEDs 40 to blink in a digitally coded pattern representative of the positions of the LEDs 40 in the component rack 12. For example, the blinking pattern may communicate bits representing the ASCII value of each character in the message serially. Other ways of encoding information in an optical signal are known to those skilled in the art and may be adapted for use with the invention. Other information, such as the position and serial number or other identification information of the component rack 12 may be contained within the digitally encoded signal.

The CPSS 19 further includes a photodiode 54 disposed on the component 50 for detecting signals transmitted by an adjacent one of the LEDs 40a-40n. The photodiode 54 is disposed on a circuit board 58 of the component 50 in a location that faces the LED strip 30. An opening 52 on the side of the component provides a path through which the photodiode 54 can receive signals from one of the LEDs 40. A local controller 56 is provided in the component 50 to receive and decode the digitally encoded optical signals transmitted by the adjacent LED 40d and received by the photodiode 54. The local controller 56 communicates with the system management agent or hardware service processor, which in turn informs the system management software 16 residing on the workstation 14. The positional information received by components may be used to ascertain the position of the components with reasonable certainty. Preferably, the transponder 72 is in communication with the microcontroller 20 so that the RPSS positional information (i.e., data regarding the rack position) can be communicated to the component along with the CPSS position information (i.e., data regarding the component position within the rack). Alternatively routes of communicating the RPSS positional information with the system management software can be devised and are considered within the scope of the present invention.

For example, in one alternative embodiment, the rack transponder need only have the capability of responding with a unique ultrasonic signal when is receives an ultrasonic signal. If the system administrator informs the system management software which rack transponder is associated with which rack (i.e., the rack transponder using frequency #6 sits on top of rack R872×987) during installation or setup, then reference transponders can communicate the position of the rack transponder using frequency #6 to the system management software and the microcontroller 20 can separately communicate the positions of the individual components within rack R872X987 to the system management software. By cross-referencing this data, the system management software knows exactly where each component is within the data center without requiring direct communication between the RPSS and the CPSS.

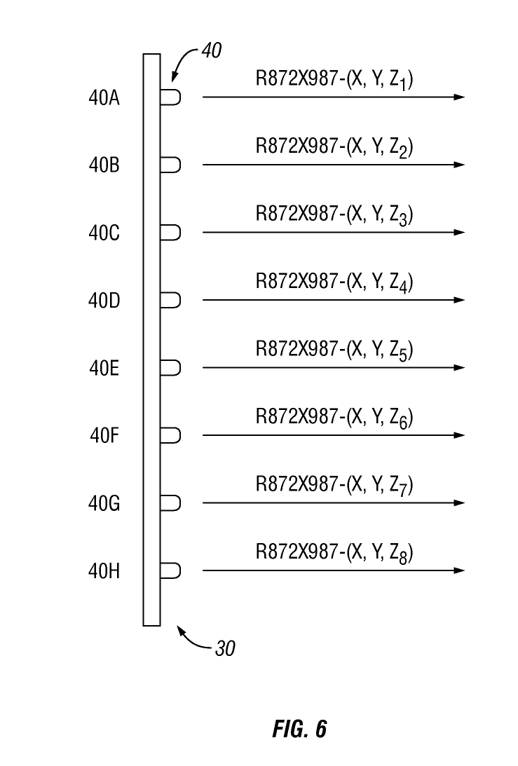

FIG. 6 is a side view of the LED strip 30 schematically illustrating the transmission of digitally encoded signals with the LEDs 40. The signals may include rack identification information, the position of the rack in the data center and the vertical position of the LEDs. In this example, the identity of the component rack 12 is determined by association with the identity of the microcontroller 20 disposed on the component rack 12. The identity of the microcontroller 20 (and, by association, the “rack ID” of the component rack 12) is a unique identification number assigned to the microcontroller 20. Here, the rack ID R872X987 is transmitted by each LED 40 in the LED strip 30. Each LED 40 also transmits a three-dimensional coordinate (X,Y,Zn), where X, Y corresponds the position of the rack in the data center and Zn corresponds to the height of the LED within the rack. For example, the LED 40a transmits “R872×987-(X,Y,Z1),” designating the rack ID of the component rack 12, the position X,Y of the component rack 12 with respect to the data center, and the height Z1 of the LED 40a.

The component 50 may receive the digitally encoded signals transmitted by any of the LEDs 40a-40n that are detected by the photodiode 54. The local controller 56 may then interpret the digitally encoded signal to extract the position of the LEDs, and use the position of the LEDs to determine the vertical position of the component 50. If the component 50 has moved since the receipt of a previous signal, the component 50 updates its position information. Typically, the component 50 will receive signals only from the LEDs 40a-40n that are substantially aligned with the photodiode 54. In situations wherein the component 50 is positioned for the photodiode to receive signals from more than one of the LEDs 40a-40n, the local controller 56 may interpolate between the positions of those LEDs to determine the position of the component 50.

If a trigger condition is met, such as a temperature of one of the components exceeding a predefined temperature threshold, the component 50 may notify the workstation 14 of the occurrence of the trigger condition and optionally communicate the positional information to the workstation 14. The workstation 14, as directed by the system management software 16, may then respond to the notification of the trigger condition by adjusting one or more parameters of the component 50 and/or other components or systems in the data center. When responding to the occurrence of the trigger condition, the workstation 14 may take into account the positional information, rack identity information, and other information transmitted by the LEDs 40.

The microprocessor 20 may direct the LEDs 40 to continuously transmit their positional information. Thus, a component 50 can be added to, or moved within, the component rack 12 at any time, and be informed of its positional information within a short period of time. Also, because the LEDs 40 may transmit positional information dynamically, the component 50 may regularly update its positional information according to its current physical location within a component rack 12. Accordingly, the system administrator 18 has access to reliable, accurate, and up-to-the-minute information regarding the physical location of the equipment 50.

Although the data center 10 uses LEDs 40 as a signal emitter and a photodiode 54 as a signal receiver, those skilled in the art will appreciate that different signal emitting and signal receiving devices could be used within the scope of the present invention. An LED-photodiode pair is just one example of a sensor system that may be used for sensing component position according to the invention. Other optical transmitters and/or receivers are known in the art. Preferably, optical signals may be generated on wavelengths outside the visible spectrum, i.e. invisible to the human eye, such as infrared signals generated by the LEDs 40 in the embodiment of FIG. 3. A laser beam is another type of optical device that may be configured as an optical signal-emitting device according to the invention.

One advantage of using an optical sensor system is that the optical sensor may transmit data without physical contact between the signal emitter and receiver. However, other types of electromechanical sensors known in the art, such as electrical switches, may be used to “sense” the position of a component within a rack. A variety of other optical or non-optical position sensors and proximity sensors known in the art may be adapted for sensing the position of components with respect to a rack according to the invention.

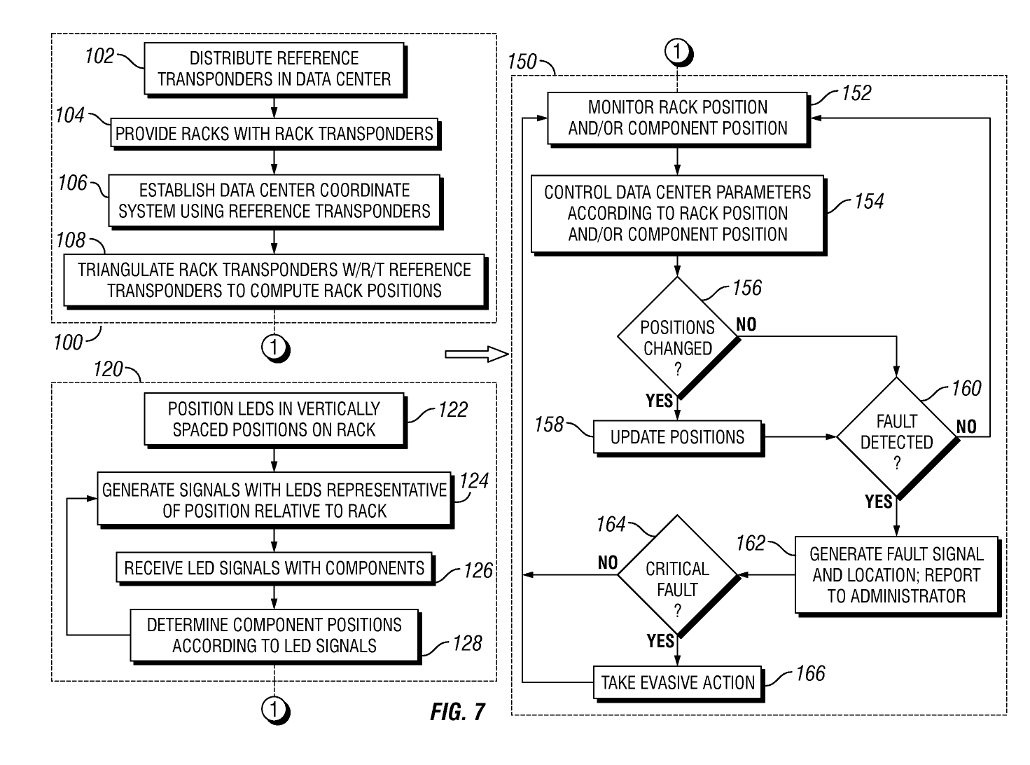

FIG. 7 is a flowchart outlining a procedure for determining the position of computer equipment in a data center and for controlling the data center according to component position and rack position. The procedure outlined in the flowchart includes a method 100 of determining the position of one or more racks with respect to a data center (“rack position”), a method 120 for optionally determining the position of components with respect to the component racks (“component position”); and a method 150 for controlling the data center according to the rack positions and/or component positions determined in methods 100 and 120. Various aspects of these methods may be performed using the systems illustrated in FIGS. 2-6.

According to the method 100 of determining rack position, a plurality of reference transponders is distributed within the data center in step 102. The reference transponders are typically ultrasonic transponders capable of generating and receiving signals on an ultrasonic (>20,000 Hz) wavelength. The reference transponders are preferably distributed at an elevation equal to or greater than the tops of the racks in the data center, to minimize potential interference of the racks with the ultrasonic signals. Typically, at least three reference transponders are preferred, while only two reference transponders may be required. The reference transponders are positioned at known locations with respect to the data center. The reference transponders may be in communication with a workstation providing global control of the data center via system management software residing on the workstation. Alternatively, the reference transponders may be “standalone” units whose coordinates are merely entered into the system management software as reference points for triangulating rack transponders, without the reference transponders being in communication with the workstation.

In step 104, each of the one or more component racks is provided with a rack transponder. Each rack transponder is preferably disposed directly on the rack, such as at the top of the rack, or at least at a known position with respect to the rack. The rack transponders are typically ultrasonic transponders capable of generating and receiving ultrasonic signals, and are capable of communicating ultrasonically with the reference transponders distributed in step 102. The rack transponders are preferably distributed at about the same elevation as the reference transponders. The rack transponders are also typically in wired communication with the workstation.

In step 106, a reference coordinate system may be established for the datacenter using the reference transponders. According to ranging techniques known in the art, and as described above in connection with FIG. 4A, two or more reference transponders (preferably three or more) may communicate with one another to establish the coordinate system. Alternatively, the positions of the reference transponders may be measured and entered into the system management software. The coordinate system may be, for example, a two-dimensional Cartesian coordinate system, a three-dimensional Cartesian coordinate system, a polar coordinate system, or variations thereof. Typically, a two-dimensional, preferably horizontal coordinate system will suffice as a reference coordinate system for locating the component racks with respect to the data center.

In step 108, the position of the rack transponders with respect to the reference transponders is determined. For example, the position of the rack transponders may be determined by triangulating each rack transponder with respect to at least two (and preferably at least three) reference transponders. In most cases, at least a two-dimensional (X,Y) rack position may be determined by triangulating with reference transponders. Alternatively, in some embodiments, sufficient positional information may be determined with reference to only two reference transponders. For example, by ranging a rack transponder with two reference transponders, the location of the rack transponder may be narrowed to two possible positions, one on either side of a line defined by the two reference transponders. Circumstantial information may then be used to determine which of the two possible positions is the most probable. For instance, one of the computed positions may fall outside of the data center, indicating that the other possible position is most likely the correct one. In either case, once the position of the rack transponder is determined, the position of the rack, itself, is known by inference.

The position of each component may also be determined, according to the method 120. First, a plurality of LEDs or other signal emitters are arranged on each rack in step 122. Typically, the LEDs are vertically arranged and spaced. The LEDs may be spaced at regular distance intervals. In step 124 the LEDs generate signals representative of their respective positions relative to the rack, as described above with reference to FIG. 3A. The signals may also include information about the position of the rack with respect to the data center, as discussed above with reference to FIG. 6. Each component disposed on the rack is provided with a signal receiver, such as a photodiode for receiving the optical signals emitted by the LEDs. In step 126, the LED signals are received by the components. The components interpret the LED signals to determine their position relative to the rack in step 128. Thus, the components may communicate their own position to a workstation and may also communicate the position of the rack on which they reside. Alternatively, the positions of the rack may be communicated separately, such as from the rack transponder to the workstation.

According to the method 150, equipment in the data center may be controlled according to the rack positions (method 100) and the component positions (method 120). In step 152, the rack positions and component positions are monitored globally using a workstation, such as that described above with reference to FIGS. 4-6. Data center operating parameters known in the art, such as blower speed, CPU voltage, processor activity level, power state, and processor clock frequency, may be regulated according to rack position and component position in step 154. These parameters may be controlled globally, such as by using the system management software residing on the workstation, and/or locally, such as with a system management agent or hardware service processor residing on each components to be controlled. For example, the airflow rate of a component may be adjusted according to its vertical position, due to the tendency of warm air to rise. In another example, airflow may be increased in a rack that reports its position as being close to a wall or other obstruction, or at a considerable distance from a data center air vent. Further, position information for the components may also be correlated with other operating parameters such as component temperature. For example, component position versus temperature may be provided to the system administrator for monitoring the components.

Positional changes may be detected according to conditional step 156. In response to these changes, the position information may be routinely updated in step 158. The updated positional information may be reported to the workstation and/or to the local controllers residing on the components. Thus, a component may be informed of its updated component position or rack position, for self-regulation by the component. These updates occur dynamically, so that, at any given moment, the system and/or system administrator have access to current positional information.

Component faults are detected in conditional step 160, examples of which include an overheating component, a malfunctioning component, a software error, or a connection failure. The data center may include any of a variety of sensors and other means of detecting these faults. In step 162, these faults are reported along with the locations of the affected components and component racks. The positional information may be used to troubleshoot the problem. The system administrator may more quickly and easily locate the affected components and component racks. This expedites the troubleshooting process, thus minimizing any equipment downtime and associated expense.

According to conditional step 164 if any faults detected in step 160 are critical, evasive action may be taken in step 166. Evasive action broadly encompasses any of a number of actions that may be used to avoid problems such as system or component failure, loss of data, inadvertent halting or improper shutting down of devices, and so forth. The evasive action may include temporarily reducing power to at least the affected component(s). In rare instances, evasive action may optionally include properly shutting down components or subsystems.

The ability to track positional information, such as the positions of component racks in a data center and the positions of components disposed in the component racks, greatly enhances the operation and maintenance of data center equipment. The equipment can generate an alert and provide its positional information automatically to the system administrator. Moreover, positional information can be automatically supplied to the component. With this information, the system management software can also create a graphical representation of equipment in the component rack for the system administrator, who can then automatically locate the equipment for upgrade or maintenance.

The present invention also desirably provides wireless tracking of computer equipment, such as by using ultrasonic transponders to determine a rack position, while using optical transmitters and receivers to detect component position. This aspect of the invention improves reliability over conventional systems and methods. Furthermore, many elements of the present invention, e.g., LEDs and photodiodes used in the CPSS and the ultrasonic transponders used in the RPSS, are readily available commercially and relatively inexpensive.

It should be recognized that the invention may take the form of an embodiment containing hardware and/or software elements, such as system management software residing on a workstation for monitoring and controlling a data center, or a system management agent or hardware service processor residing on a component. Non-limiting examples of software include firmware, resident software, and microcode. More generally, the invention can take the form of a computer program product accessible from a computer-readable medium providing program code for use by or in connection with a computer or any instruction execution system. For the purposes of this description, a computer-usable or computer readable medium can be any apparatus that can contain, store, communicate, propagate or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), and DVD.

A data processing system suitable for storing and/or executing program code typically includes at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution.

Input/output (I/O) devices such as keyboards, displays, or pointing devices can be coupled to the system, either directly or through intervening I/O controllers. Network adapters may also be used to allow the data processing system to couple to other data processing systems or remote printers or storage devices, such as through intervening private or public networks. Modems, cable modems, Ethernet cards, and wireless network adapters are examples of network adapters.

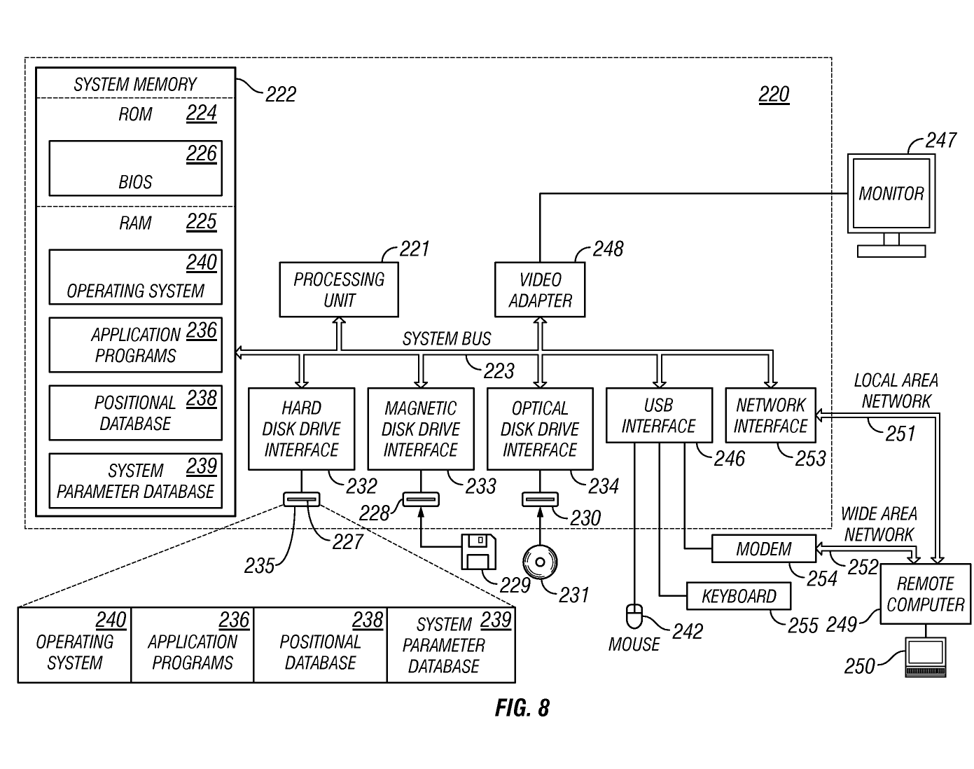

FIG. 8 is a schematic diagram of a computer system generally indicated at 220 that may be configured for tracking and controlling computer equipment according to the invention. The computer system 220 may be, for example, a workstation for globally monitoring and controlling data center equipment, a server blade being monitored and controlled by the workstation, or some combination or sub-combination of the two. Generally, computer system 220 includes a processing unit 221, a system memory 222, and a system bus 223 that couples various system components, including the system memory 222 to processing unit 221. System bus 223 may be any of several types of bus structures including a memory bus or memory controller, a peripheral bus, and a local bus using any of a variety of bus architectures. The system memory includes a read only memory (ROM) 224 and random access memory (RAM) 225. A basic input/output system (BIOS) 226 is stored in ROM 224, containing the basic routines that help to transfer information between elements within computer system 220, such as during start-up.

Computer system 220 further includes a hard disk drive 235 for reading from and writing to a hard disk 227, a magnetic disk drive 228 for reading from or writing to a removable magnetic disk 229, and an optical disk drive 230 for reading from or writing to a removable optical disk 231 such as a CD-R, CD-RW, DV-R, or DV-RW. Hard disk drive 235, magnetic disk drive 228, and optical disk drive 230 are connected to system bus 223 by a hard disk drive interface 232, a magnetic disk drive interface 233, and an optical disk drive interface 234, respectively. Although the exemplary environment described herein employs hard disk 227, removable magnetic disk 229, and removable optical disk 231, it should be appreciated by those skilled in the art that other types of computer readable media which can store data that is accessible by a computer, such as magnetic cassettes, flash memory cards, digital video disks, Bernoulli cartridges, RAMs, ROMs, USB Drives, and the like, may also be used in the exemplary operating environment. The drives and their associated computer readable media provide nonvolatile storage of computer-executable instructions, data structures, program modules, and other data for computer system 220. For example, the operating system 240 and application programs 236 may be stored in the RAM 225 and/or hard disk 227 of the computer system 220.

A user may enter commands and information into computer system 220 through input devices, such as a keyboard 255 and a mouse 242. Other input devices (not shown) may include a microphone, joystick, game pad, touch pad, satellite dish, scanner, or the like. These and other input devices are often connected to processing unit 222 through a USB (universal serial bus) 246 that is coupled to the system bus 223, but may be connected by other interfaces, such as a serial port interface, a parallel port, game port, or the like. A display device 247 may also be connected to system bus 223 via an interface, such as a video adapter 248. In addition to the monitor, personal computers typically include other peripheral output devices (not shown), such as speakers and printers. These peripheral and input/output devices may be included with, for example, the workstation that a system administrator may use to monitor and control computer equipment in the data center.

The computer system 220 may operate in a networked environment using logical connections to one or more remote computers 249. For example, the computer system 220 may be a workstation for monitoring and controlling equipment in the data center, while the one or more remote computers 249 may include one or more rack-mounted server blades to be monitored and controlled in the data center. Remote computer 249 may be another personal computer, a client, a router, a network PC, a peer device, a mainframe, a personal digital assistant, an internet-connected mobile telephone or other common network node. While a remote computer 249 typically includes many or all of the elements described above relative to the computer system 220, only a memory storage device 250 has been illustrated in FIG. 8. The logical connections depicted in the figure include a local area network (LAN) 251 and a wide area network (WAN) 252. Such networking environments are commonplace in offices, enterprise-wide computer networks, intranets, and the internet.

When used in a LAN networking environment, the computer system 220 is often connected to the local area network 251 through a network interface or adapter 253. When used in a WAN networking environment, the computer system 220 typically includes a modem 254 or other means for establishing high-speed communications over WAN 252, such as the internet Modem 254, which may be internal or external, is connected to system bus 223 via USB interface 246. In a networked environment, program modules depicted relative to computer system 220, or portions thereof, may be stored in the remote memory storage device 250. It will be appreciated that the network connections shown are exemplary and other means of establishing a communications link between the computers may be used.

Program modules may be stored on hard disk 227, optical disk 231, ROM 224, RAM 225, or even magnetic disk 229. The program modules may include portions of an operating system 240, application programs 236, or the like. A positional database 238 is optionally included, for dynamically tracking updated positional information for data center equipment, as determined by an RPSS and/or CPSS according to the invention. A system parameter database 239 may also be included, containing parameters of the data center to be controlled in response to the positional information dynamically updated and stored in the positional database 238.

Aspects of the present invention may be implemented in the form of application program 236. Application program 236 may be informed by or otherwise associated with positional database 238 and/or system parameter database 239. The application program 236 generally comprises computer-executable instructions for tracking the position of computer equipment in the data center, including rack positions and component positions. The application program 236 may, therefore, include instructions for controlling the ultrasonic communication between reference transponders and rack transponders discussed above for determining rack position, as well as instructions for controlling the LED-photodiode pairs or other signal transmitter/receiver pairs discussed above for determining component position. The application program 236 may further include instructions for reporting positional information to the components or workstation, for detecting faults within the data center, instructions for alerting a system administrator of faults and the positional information for affected components and component racks, and instructions for performing other functions described above. For example, in one embodiment, the application program 236 may include instructions for determining the position of a selected component rack with respect to the data center by ultrasonically communicating between the associated rack transponder and the at least two reference transponders, instructions for communicating the position of the selected component rack to a component disposed in the selected component rack, and instructions for controlling the component according to the position of the selected component rack with respect to the data center.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method, comprising:
providing one or more ultrasonic rack transponders associated with a respective one or more component racks in a data center;
providing at least two ultrasonic reference transponders at known locations with respect to the data center; and
determining the position of a selected component rack with respect to the data center by ultrasonically communicating between the associated rack transponder and the at least two reference transponders.

2. The method of claim 1, further comprising establishing an at least two-dimensional reference coordinate system of the data center using the at least two reference transponders.

3. The method of claim 2, wherein the step of establishing the at least two-dimensional reference coordinate system of the data center comprises defining a first reference transponder as an origin of the reference coordinate system, determining the position of a second reference transponder with respect to the first reference transponder by communicating ultrasonically between the first and second reference transponders, and ultrasonically determining a position of the third reference transponder with respect to the first and second reference transponders by communicating ultrasonically between the third reference transponder and the first and second reference transponders.

4. The method of claim 1, further comprising communicating the position of the selected component rack to a controller, and controlling one or more components in the data center according to the position of the selected component rack.

5. The method of claim 4, wherein the controller includes one or both of a local processor included with each of the one or more components and a workstation networked with the one or more components.

6. The method of claim 1, further comprising:
providing a plurality of signal emitting elements within the selected component rack;
transmitting continuously and automatically positional information from the rack to one or more components disposed in the component rack using one or more of the signal emitting elements;
receiving the positional information in the one or more components; and
causing the component to report the positional information, such that the location of the one or more components with respect to the component rack can be determined.

7. The method of claim 6, further comprising controlling the one or more components according to the positional information.

8. The method of claim 7, wherein the step of controlling the one or more components comprises adjusting one or more component parameters selected from the group consisting of a blower speed, a CPU voltage, a processor activity level, a power state, and a processor clock frequency.

9. The method of claim 1, wherein the rack transponders are rigidly coupled to their associated one or more component racks.

10. A computer program product comprising a computer usable medium including computer usable program code for determining the position of a component rack in a data center, the computer program product including:
computer usable program code for detecting the position of the component rack with respect to the data center by triangulating the associated rack transponder with respect to at least two reference transponders disposed at non-collinear locations in the data center.

11. The computer program product of claim 10, further comprising computer usable program code for establishing an at least two-dimensional reference coordinate system of the data center using the at least two reference transponders.

12. The computer program product of claim 11, wherein the computer usable program code for establishing the at least two-dimensional reference coordinate system of the data center comprises computer usable program code for selecting a first reference transponder as an origin of the reference coordinate system, computer usable program code for ultrasonically determining the position of a second reference transponder with respect to the first reference transponder, and computer usable program code for ultrasonically determining a position of the third reference transponder with respect to the first and second reference transponders.

13. The computer program product of claim 10, further comprising computer usable program code for controlling one or more components disposed in the component rack according to the detected position of the component rack.

14. The computer program product of claim 10, further comprising:
computer usable program code for transmitting continuously and automatically positional information from a plurality of signal emitting elements within the selected component rack to a component disposed in the component rack;
computer usable program code for receiving the positional information in the component; and
computer usable program code for reporting the positional information to a system controller.

15. The computer program product of claim 14, further comprising computer usable program code for controlling the component according to the positional information.

16. The computer program product of claim 15, wherein the computer usable program code for controlling the component includes computer usable program code for adjusting one or more component parameters selected from the group consisting of a blower speed, a CPU voltage, a processor activity level, a power state, and a processor clock frequency.

17. A system for detecting the position of computer equipment in a data center, comprising:
a plurality of ultrasonic reference transponders disposed at non-collinear locations in the data center;
a component rack configured for housing a plurality of components; and
an ultrasonic rack transponder disposed in a fixed relationship with respect to the component rack and configured for communicating with the reference transponders for determining the position of the component rack with respect to the data center.

18. The system of claim 17, further comprising a controller in electronic communication with the reference transponders for controlling ultrasonic communication between the reference transponders and establishing an at least two-dimensional coordinate system using the reference transponders.
